(19) United States
(12) Patent Application Publication
(10) Pub. No.: US 2026/0066675 A1
(43) Pub. Date: Mar. 5, 2026

(54) INVERTER SYSTEM AND METHOD FOR OPERATING SAID INVERTER SYSTEM

(71) Applicant: Fronius International GmbH, Pettenbach (AT)

(72) Inventors: Johannes GRAF, Pettenbach (AT); Philipp RECHBERGER, Pettenbach (AT)

(73) Assignee: Fronius International GmbH, Pettenbach (AT)

(21) Appl. No.: 19/126,876

(22) PCT Filed: Nov. 7, 2023
(86) PCT No.: PCT/EP2023/081009

§ 371 Date: May 2, 2025

(30) Foreign Application Priority Data
Nov. 7, 2022 (EP) 22205834.9

(51) Int. Cl. H02J 7/35; H02J 3/14; H02J 3/46

(52) U.S. Cl. CPC H02J 7/35; H02J 3/17; H02J 3/466; H02J 2101/25; H02J 2207/20

(57) ABSTRACT

The present invention relates to an inverter system (INV) for a photovoltaic system and to a method for operating the inverter system (INV). The inverter system (INV) comprises an inverter unit (WE), ), to which a predetermined number of DC-to-DC converters (B1, . . . , B4) is connected upstream via an intermediate circuit (ZK). The DC inputs (DC1, . . . , DC4) of the inverter system (INV) are formed by the DC-to-DC converters (B1, . . . , B4), which predetermines the number and properties of the DC inputs (DC1, . . . , DC4). The DC inputs (DC1, . . . , DC4) are connected to different direct-voltage units (PV1, PV2, BAT, EC, GE, VB), in particular PV units, energy storage units, etc. A switching unit (SE), which comprises inputs (E1, . . . , E6) for connecting the direct-voltage units (PV1, PV2, BAT, EC, GE, VB), is connected to the DC inputs (DC1, . . . , DC4). The switching unit (SE) is thus arranged between the DC-to-DC converters (B1, . . . , B4) forming the DC inputs (DC1, . . . , DC4) and the direct-voltage units (PV1, PV2, BAT, EC, GE, VB) which are connectable to the switching unit (SE). The different direct-voltage units (PV1, PV2, BAT, EC, GE, VB) connected to the inputs (E1, . . . , E6) are identified (101, 102), and for each direct-voltage unit (PV1, PV2, BAT, EC, GE, VB) connected to an input (E1, . . . , E6) of the switching unit (SE) a current value of at least one power variable is determined (103). The determined current value of the at least one power variable is then compared with at least one predetermined threshold value (104). Depending on a respective comparison result, the switching unit (SE) then establishes a connection between the respectively connected direct-voltage unit (PV1, PV2, BAT, EC, GE, VB) and at least one suitable DC input (DC1, . . . , DC4) and/or adapts the connection (105).

### TECHNICAL FIELD

The present invention relates generally to the field of electrical engineering, in particular to the field of power electronics and power electronic circuits. In particular, the present invention relates to an inverter system for a photovoltaic system. The inverter system comprises an inverter unit, to which a predetermined number of DC-to-DC converters is connected upstream via an intermediate circuit. The DC inputs of the inverter system are formed by the DC-to-DC converters, which predetermine the number and properties of the DC inputs. The DC inputs can be connected to different direct-voltage units, particularly PV units, energy storage units, etc. Furthermore, the present invention also relates to an associated method for operating the inverter system for the photovoltaic system.

### PRIOR ART

Inverters are usually used where a direct voltage from an electrical energy source, such as a photovoltaic (PV) unit, a battery, etc., is converted to a suitable alternating voltage so that it can be fed into a supply network or used directly to supply consumers. Typically, an inverter connects at least one direct voltage source which generates or supplies energy on the input side to an alternating-voltage network which is connected on the output side. In the case of a bidirectional inverter, for example, a direct-voltage consumer, such as a battery to be charged, etc., can also be charged or supplied with electrical energy from a connected energy source (e.g., PV unit) or from the supply network.

Nowadays, inverters or inverter systems—when used as what are known as solar inverters—play an important role in renewable energy generation using solar energy. Photovoltaic systems, or PV systems for short, are used to generate energy using solar energy and generate electrical energy from light, in particular sunlight. A photovoltaic system typically uses photovoltaic cells, which are usually combined to form larger photovoltaic units, or PV units for short, such as PV modules or PV strings, which also consist of appropriately connected PV modules. PV units are direct voltage sources which generate electrical energy in the form of direct voltage or direct current from solar energy or sunlight. To feed the generated direct voltage to a supply network or to make it available to consumers, the PV units are connected to direct voltage or DC inputs of inverters or inverter systems, which convert the direct voltage generated in the PV units to a suitable alternating voltage. An inverter or an inverter system is therefore an essential part of a PV system.

Inverter systems used in PV systems usually comprise a single-or three-phase inverter unit, usually a DC-to-AC converter, on the output side. The DC-to-AC converter converts the direct voltage generated by the at least one PV unit connected to the inverter system to a suitable alternating voltage so that it can be fed to the supply network. Furthermore, the inverter unit or the DC-to-AC converter can, for example, automatically synchronize with the supply network.

On an input side of the inverter system, one or more direct-voltage converters or DC-to-DC converters are provided, depending on whether only one PV unit or several PV units and, if necessary, another, additional direct-voltage unit (e.g., stationary battery) are to be connected. A DC-to-DC converter is an electrical circuit which converts a direct voltage supplied at the input (e.g., output voltage of a PV unit, direct voltage from a battery, etc.) to an output voltage with a higher, equal or lower voltage level. The voltage level of the output voltage of the DC-to-DC converter can be defined, for example by a minimum input voltage required by the DC-to-AC converter of the inverter system.

Due to the input-side arrangement of the DC-to-DC converters in the inverter system, the inputs of the DC-to-DC converters also form the DC inputs of the inverter system. This means that the number of DC-to-DC converters on the input side defines the number of DC inputs of the inverter system. Furthermore, the dimensioning and design of the DC-to-DC converter used also define the properties and input parameters of the particular DC input. This means that the design of the particular DC-to-DC converter determines, for example, a voltage range, a maximum current, a maximum power of the particular DC input and whether the DC input can be used unidirectionally or bidirectionally.

DC-to-DC converters also allow for a wide range of voltage transfer ratios. This means that the operating point of each connected PV unit, at which as much energy as possible is emitted, can be varied within wide limits (e.g., by means of so-called maximum power point tracking) or optimally adapted to conditions such as solar radiation, temperature, shading effects, etc. In solar inverter systems, DC-to-DC converters are therefore usually used as DC inputs, which are designed as step-up converters or boost converters or step-up/step-down converters or buck-boost converters. These converters can also be referred to as boosters because of their step-up function, i.e., an input voltage can be converted to an output voltage with a higher voltage level. This means that, for example, power can be fed to the supply network even when the output voltage of a PV unit is low.

An intermediate circuit is usually provided between the one or more input-side DC-to-DC converters and the output-side inverter unit or DC-to-AC converter. The intermediate circuit is usually formed by a capacitor and is fed by one or more DC-to-DC converters on the input side. Furthermore, the intermediate circuit supplies the input voltage for the output-side inverter unit or DC-to-AC converter of the inverter system.

However, in addition to one or more PV units, other direct voltage sources or direct voltage loads or consumers can also be connected to an inverter system. For example, a stationary energy storage unit (e.g., battery) can be connected to the inverter system. The energy storage unit can, for example, be charged with excess energy generated by the PV units, which can be used, for example, to optimize self-consumption in feed-in mode and/or to supply energy during times of little or no solar radiation (e.g., at night, in bad weather, etc.). Furthermore, it is also conceivable that other direct voltage sources, such as a DC generator, can be integrated into the PV system as a back-up in the event of low or no solar radiation by connecting them to the inverter system. Furthermore, it is also possible to integrate direct voltage loads or consumers, such as a DC charging device for an electric car, a direct voltage-operated heating unit, etc. into the PV system by means of the inverter system. As a result, all direct voltage sources (e.g., energy storage units, batteries, etc.) which can be connected to an inverter system, as well as PV units and direct voltage loads or consumers, are summarized under the term “direct-voltage unit” or “direct-voltage units.”

If, for example, several different direct-voltage units-e.g., several differently aligned PV units, energy storage units, consumers, DC generators, etc.-are to be connected to the DC inputs of an inverter system, it must be considered, when planning and installing the PV system, that the direct-voltage units each have different properties and performance parameters. For example, direct voltage sources (e.g., PV units, DC generators) only supply electrical energy or power to the inverter system, while direct voltage loads or consumers only obtain electrical energy or power by means of the inverter system from one of the connected direct voltage sources and/or from the connected energy supply network. This means that the DC-to-DC converters to which, for example, direct voltage sources are connected must act as direct voltage loads and transfer the power from the direct voltage source to the inverter unit. DC-to-DC converters to which direct voltage loads are connected must, for example, function as direct voltage sources or transfer the power in a different direction than DC-to-DC converters which function as direct voltage loads. If, for example, an energy storage unit (e.g., stationary battery) is integrated into the PV system, it must be considered that the corresponding DC input of the inverter system or the associated DC-to-DC converter is designed bidirectionally in order to be able to charge the energy storage unit and, if necessary, discharge it. Furthermore, the different performance parameters of the direct-voltage units to be connected, such as supplied and/or consumed power, voltage and/or current, must also be considered. The performance parameters of individual direct-voltage units can also change. The power or output voltage delivered by a PV unit can vary depending on solar radiation, temperature, weather conditions, etc. For energy storage units, for example, a particular charging/discharging current or a particular charging/discharging voltage, charging status (state of charge or SoC), discharging status (depth of discharge or DoD), etc. must be considered. Furthermore, it may also happen that not every direct-voltage unit needs to be permanently connected to the inverter system. For example, a charged energy storage unit or a back-up DC generator can be switched off. Even differently aligned PV units can require a different number or differently designed DC inputs of the inverter system, for example depending on the present solar radiation and the resulting power or output voltage.

If a large number of different direct-voltage units with different properties and partially variable performance parameters are to be provided in a PV system, this usually results in complex planning and complex installation of the system. For example, it is important to consider exactly which DC input of the inverter system is suitable for connecting the particular direct-voltage unit. This means that the particular DC input must have the properties suitable for the direct-voltage unit to be connected, such as permissible voltage range, maximum permissible current, maximum permissible power, direction of power transmission or uni- or bi-directionality, etc., in order to allow trouble-free and efficient operation of this direct-voltage unit and the entire PV system.

One way of considering different direct-voltage units or their different properties in a PV system is to provide several differently designed or dimensioned inverter systems, for example. These can, for example, have a different number of DC inputs which are specifically adapted to the properties of the direct-voltage units to be connected. This means that, in the worst case scenario, at least one separate inverter system must be provided for each type of direct-voltage unit to be connected. As a result, the PV system not only has high costs and many components, but is also very complex to install. Furthermore, it can be disadvantageous that the number of DC inputs of the inverter system used is not used optimally. For example, there may be too few DC inputs for one type of direct-voltage unit to be connected, at least temporarily, while other DC inputs are hardly used or not used at all.

Another way to integrate different types of direct-voltage units with different properties into a PV system would be to use an inverter system with correspondingly large DC-to-DC converters, for example. This means that in the inverter system, for example, DC-to-DC converters are used as DC inputs, which DC-to-DC converters are dimensioned for a correspondingly large voltage range, a correspondingly large maximum current and/or power and are ideally designed to be bidirectional so that as many different direct-voltage units as possible can be connected to these DC inputs. However, this approach has the disadvantage that the DC inputs of the inverter system may be oversized for some direct-voltage units, for example. This can lead to relatively inefficient use of the inverter system. Furthermore, an inverter system having correspondingly large DC-to-DC converters has a corresponding size and a corresponding weight and can be expensive both to manufacture and to purchase.

### REPRESENTATION OF THE INVENTION

The invention is therefore based on the object of providing an inverter system for a photovoltaic system and an associated method for operating the inverter system, with which a predetermined number of DC inputs having properties defined by DC-to-DC converters used in the inverter system can be used efficiently in a temporally variable and flexible manner for different direct-voltage units.

This object is achieved by methods for operating an inverter system and by an associated inverter system according to the independent claims. Advantageous embodiments of the present invention are described in the dependent claims.

According to the invention, the object is achieved by a method for operating an inverter system for a photovoltaic system comprising an inverter unit, to which a predetermined number of DC-to-DC converters is connected upstream via an intermediate circuit. The DC-to-DC converters form DC inputs of the inverter system and predetermines a number and properties of the DC inputs, wherein the DC inputs are connected to different direct-voltage units (e.g., PV units, energy storage units, etc.), wherein a switching unit is connected to the DC inputs, which switching unit comprises inputs for connecting direct-voltage units. Different direct-voltage units are connected to these inputs of the switching unit, wherein the switching unit is arranged between the DC-to-DC converters forming the DC inputs of the inverter system and the connectable direct-voltage units. The different direct-voltage units connected to the inputs of the switching unit are then identified. For this purpose, a current value of at least one power variable is determined for each direct-voltage unit connected to an input of the switching unit. The determined current value of the at least one power variable is then compared with at least one predetermined threshold value. Depending on the respective comparison result, the switching unit then establishes a connection between the respectively connected direct-voltage unit and at least one suitable DC input and/or adapts the connection accordingly.

The main aspect of the proposed solution is that a predetermined number of DC inputs of the inverter system, which can have predetermined properties due to the DC-to-DC converters used—such as permissible voltage range, maximum permissible current and/or power, etc., can be used variably over time. Furthermore, the process allows the DC inputs to be used flexibly for different direct-voltage units in a simple and efficient manner. This means that direct-voltage units can ideally be connected to any of the inputs of the switching unit and the switching unit then connects them, as required, to a DC input which has the properties suitable for the respective direct-voltage unit. The suitable DC input for the particular direct-voltage unit is determined based on the particular determined current value of the power variable and by comparison with a predetermined threshold value (e.g., current, voltage and/or performance limits). This means that a connection between the respectively connected direct-voltage unit and at least one suitable DC input of the inverter system is assigned and established by the switching unit depending on the respective comparison result. It is advantageous if an input or output voltage, an input or output voltage and/or a power of the respectively connected direct-voltage unit is used as the power variable.

Furthermore, the method according to the invention only takes into account those direct-voltage units which are currently “active” or which supply or receive energy, for example by the inverter system. Especially “inactive” direct-voltage units, such as a charged energy storage unit which is not currently needed, a PV unit e.g., at night or when there is insufficient sunlight, etc., are not taken into account when establishing the connection or an existing connection of an “inactive” direct-voltage unit to a DC input is disconnected to make the DC input usable for another “active” direct-voltage unit. This means that the method according to the invention ideally offers the possibility for the switching unit to assign the connections between the direct-voltage units and the DC inputs in a flexible and needs-oriented manner. For example, existing connections between the direct-voltage units and DC inputs can be disconnected by the switching unit according to the respective comparison result or replaced by other connections which have the properties required for the direct-voltage unit. Furthermore, an existing connection can be supplemented by another connection depending on the comparison result.

A suitable embodiment of the method provides that the current value of the at least one power variable is determined again at predetermined time intervals for each of the direct-voltage units connected to the inputs of the switching unit. This makes it easy to determine, especially during operation of the inverter system, whether there have been any changes in the power variables of the connected DC units—i.e., whether, for example, a PV unit is generating more, less or hardly any energy due to changes in solar radiation, shading, etc., or whether, for example, an energy storage unit has changed its charge or discharge status, etc. These changes can then be easily taken into account in the connections between the connected DC units and the suitable DC inputs.

After the direct-voltage units have been connected to the inputs of the switching unit, ideally at least one characteristic value can be entered for each of the connected direct-voltage units to identify the respectively connected direct-voltage units. For example, the at least one characteristic value of the particular direct-voltage unit can be entered manually, wherein an output voltage, a maximum output current and/or a maximum output power can be used as a characteristic value, for example for direct voltage sources (e.g., PV unit, etc.), a charging/discharging voltage, a maximum charging/discharging current, a state of charge, etc. for batteries, or an input voltage, a maximum input current and/or a maximum power for direct voltage loads (e.g., consumers, etc.).

Alternatively, after the direct-voltage units have been connected to the inputs of the switching unit, at least one characteristic value of each of the connected direct-voltage units can be automatically determined for identification of the respectively connected direct-voltage units. An automatic determination of at least one characteristic value for each connected direct-voltage unit can be carried out, for example, by means of measurement, by scanning a current-voltage curve or a UI scan or, for example, by reading data from the connected direct-voltage unit by a data connection (e.g., PLC, Modbus, etc.).

Ideally, the inputs of the switching unit, to which the direct-voltage units are connected, can be freely assigned to the different direct-voltage units. This means that when connecting the direct-voltage units to the switching unit, it is not necessary to pay attention to which direct-voltage unit is connected to which input of the switching unit. The DC units can be easily connected to the switching unit according to availability of inputs, order of installation, etc.

It is also advantageous if each connected direct-voltage unit is assigned a priority, which is taken into account when establishing the connection to the at least one DC input. This makes it easy to specify which connected direct-voltage units are preferably connected to the DC inputs via the switching unit. This priority can be assigned, for example, when connecting and identifying the direct-voltage units.

The solution to the above object is also achieved by an inverter system for a photovoltaic system comprising an inverter unit. A predetermined number of DC-to-DC converters are connected upstream of the inverter unit by an intermediate circuit, wherein the DC-to-DC converters form the DC inputs of the inverter system and predetermine a number and properties of the DC inputs. The DC inputs can be connected to different direct-voltage units (e.g., PV units, energy storage units, etc.). Furthermore, the inverter system comprises a switching unit comprising inputs for connecting the different direct-voltage units and outputs for connecting to the DC inputs. The switching unit is arranged between the DC-to-DC converters of the inverter system forming the DC inputs and the connectable direct-voltage units. Furthermore, the switching unit is configured to determine a current value of at least one power variable for each of the direct-voltage units connected to the inputs, to compare the determined current value of the at least one power variable of the direct-voltage units connected to the inputs with at least one predetermined threshold value and, depending on a respective comparison result, to establish a connection of the respectively connected direct-voltage units to at least one suitable DC input and/or to adapt the connection.

The inverter system can therefore be used flexibly and at different times, in particular owing to the switching unit, which can be configured as an independent switching unit (e.g., with its own housing) which is connected between the DC inputs and the direct-voltage units to be connected, or can be integrated into the inverter system (i.e., installed in a housing with the other components of the inverter system). Different direct-voltage units can be connected to the inputs of the switching unit, which can then be flexibly connected by the switching unit to a suitable DC input as required. This means that the switching unit connects the particular direct-voltage units to at least one suitable DC input depending on the respective comparison result between the particular current value of at least one power variable of the respectively connected direct-voltage units and at least one predetermined threshold value. For this purpose, the switching unit can, for example, connect a direct-voltage unit to a suitable “free” DC input (i.e., the DC input is not yet used for a direct-voltage unit). Alternatively or additionally, the switching unit can also adapt existing connections between direct-voltage units and DC inputs, for example by the switching unit adding another connection to an existing connection or by the switching unit, for example, disconnecting an existing connection or by the switching unit replacing an existing connection with another connection.

Ideally, the number of inputs of the switching unit is greater than or at least equal to the predetermined number of DC-to-DC converters and thus the number of DC inputs. This further increases the flexibility of the inverter system, since direct-voltage units which are at least temporarily unused—e.g., an energy storage unit which is not currently being charged or from which no energy is currently being drawn—can remain connected to the switching unit without occupying an input which would be needed for another direct-voltage unit, for example.

It is also advantageous if at least one DC-to-DC converter of the inverter system is configured as a bidirectional DC-to-DC converter. This means that both direct voltage sources (e.g., PV units) and direct voltage loads (e.g., consumers) can be connected to the inverter system and an energy storage unit (e.g., stationary battery) can be conveniently charged and discharged again when energy is required.

In a suitable embodiment of the inverter system, the DC-to-DC converters have the same dimensioning and the same design in terms of voltage range, maximum permissible current and/or maximum permissible power. Alternatively, the DC-to-DC converters can also be dimensioned and configured for different voltage ranges, different maximum permissible currents and/or different maximum permissible power, whereby the inverter system has DC inputs which are better adapted for connections to DC units with different requirements for e.g., input voltage, maximum permissible current, maximum permissible power, etc.

Furthermore, it is advantageous if the switching unit comprises at least one switching network for connecting the connected direct-voltage units to the DC inputs and a control component. The control component can determine the current value of the at least one power variable of the direct-voltage units connected to the inputs and compare the determined value of the at least one power variable with at least one threshold value. In addition, the control component is configured to evaluate the relevant comparison result and control the switching network accordingly. Ideally, the control component can be integrated into a control unit of the inverter system, for example to save additional components.

### BRIEF DESCRIPTION OF THE FIGURES

The present invention will be described in greater detail below with reference to FIG. 1 to 4, which by way of example show schematic and non-limiting advantageous embodiments of the invention. In the figures:

FIG. 1 shows an inverter system according to the invention for a photovoltaic system with different connected direct-voltage units;

FIG. 2 shows a sequence of the method for operating the inverter system according to the invention;

FIG. 3a shows a first application example for the use of the inverter system according to the invention;

FIG. 3b shows a second application example for the use of the inverter system according to the invention;

FIG. 3c shows a third application example for the use of the inverter system according to the invention; and

FIG. 4 shows a combination of at least two or more inverter systems according to the invention.

### EXECUTION OF THE INVENTION

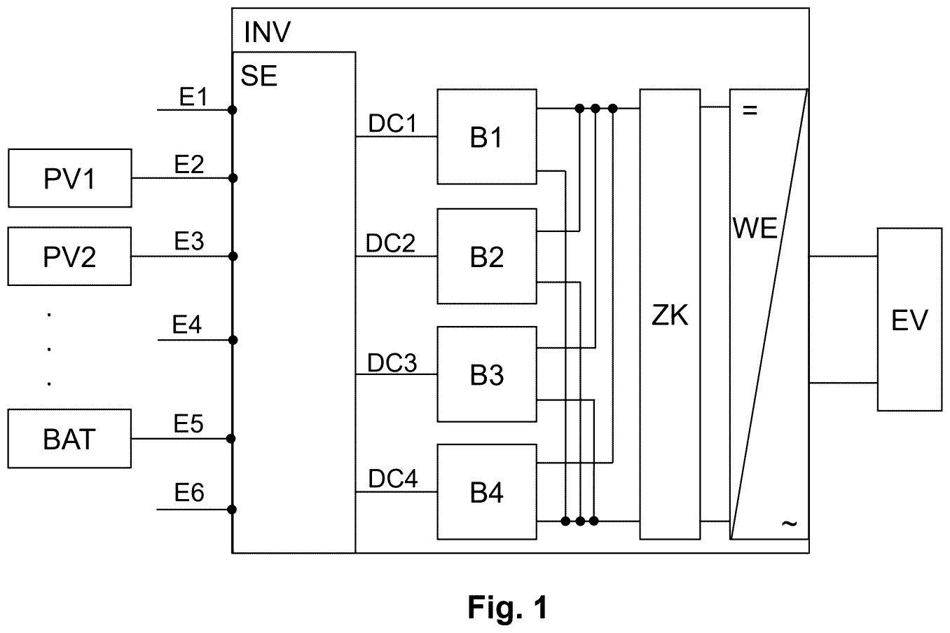

FIG. 1 is a schematic overview of an inverter system INV. The inverter system INV has an inverter unit WE on the output side, which is not described in more detail. The inverter unit WE can, for example, be designed as a single- or three-phase DC-to-AC converter. The output of the inverter unit WE forms the output of the inverter system INV, which in turn is connected to a single- or three-phase supply network EV and/or consumers. On an input side of the inverter unit WE, an intermediate circuit ZK is arranged, which can be formed, for example, by a capacitor and supplies the input voltage for the inverter unit WE. A predetermined number of DC-to-DC converters B1, B2, B3, B4 is arranged upstream of the intermediate circuit ZK and therefore of the inverter unit WE, the outputs of which DC-to-DC converters are each connected in parallel with the intermediate circuit ZK.

The DC-to-DC converters B1, B2, B3, B4 can be configured, for example, as step-up converters or as so-called boost converters or as step-up/step-down converters or as so-called buck-boost converters and are often simply referred to as boosters B1, B2, B3, B4. The inputs of the DC-to-DC converters B1, B2, B3, B4 also form the direct voltage or DC inputs DC1, DC2, DC3, DC4 of the inverter system INV. The number of DC-to-DC converters B1, B2, B3, B4 used in the inverter system INV determines the number of DC inputs DC1, DC2, DC3, DC4. The inverter system INV shown as an example in FIG. 1 has, for example, four DC-to-DC converters B1, B2, B3, B4 and thus four DC inputs DC1, DC2, DC3, DC4. However, the inverter system INV can also have a larger or smaller number of DC-to-DC converters B1, B2, B2, B4 and a corresponding number of DC inputs DC1, DC2, DC3, DC4.

The DC inputs DC1, DC2, DC3, DC4 of the inverter system INV can be connected to different direct-voltage units PV1, PV2, BAT, such as PV units PV1, PV2, stationary energy storage units or batteries BAT, direct-voltage charging devices EC for an electric car, direct current or DC consumers VB (e.g., DC heating unit) and/or direct voltage sources GE (e.g., DC generator GE). FIG. 1 shows two PV units PV1, PV2 and a battery BAT, which are connected to the inverter system INV.

Furthermore, the dimensioning and design of the DC-to-DC converters B1, B2, B3, B4 used in the inverter system INV determines the properties of the DC inputs DC1, DC2, DC3, DC4 with regard to, for example, the permissible voltage range, the maximum permissible current and/or the maximum permissible power. The design of the respective DC-to-DC converters B1, B2, B3, B4 also determines whether a DC input can be used unidirectionally or bidirectionally. For example, either only direct voltage sources, such as PV units PV1, PV2, DC generators GE or a battery BAT when discharging, or only direct voltage loads, such as a DC consumer VB, a charging device EC for an electric car or a battery BAT when charging, can be connected to a unidirectional DC input DC1, DC2, DC3, DC4. This means that the design and dimensioning of a particular DC-to-DC converter B1, B2, B3, B4 determine for which direct-voltage unit PV1, PV2, BAT the particular DC input DC1, DC2, DC3, DC4 of the inverter system INV can be used or whether, for example, two direct-voltage units PV1, PV2, such as PV units PV1, PV2 at the same voltage level can be connected to the same DC-to-DC converter B1, B2, B3, B4 or to the same DC input DC1, DC2, DC3, DC4.

The DC-to-DC converters B1, B2, B3, B4 used in the inverter system INV can, for example, have the same dimensioning and design with respect to a voltage range, in particular input voltage range, a maximum permissible current (e.g., a maximum of 20 amperes) and/or a maximum permissible power. This means that, for example, all DC inputs DC1, DC2, DC3, DC4 have the same properties.

Alternatively, the DC-to-DC converters B1, B2, B3, B4 can also be dimensioned and configured for different voltage ranges, in particular input voltage ranges, different maximum permissible currents and/or different maximum permissible powers. This means that the DC inputs DC1, DC2, DC3, DC4 have different properties, which means that some DC inputs are better suited for connection to some direct-voltage units PV1, PV2, BAT than others.

If, as shown in FIG. 1 by way of example, in addition to PV units PV1, PV2, a stationary battery BAT is also to be used—e.g., to store excess energy generated for optimization in feed-in operation and/or as an energy storage device for times with little or no solar radiation—it is useful, if at least one of the DC-to-DC converters B1, B2, B3, B4 and thus one of the DC inputs DC1, DC2, DC3, DC4 is configured to be bidirectional so that the battery BAT can be charged and discharged thereby.

In the inverter system INV according to the invention, a switching unit SE is arranged between the DC inputs DC1, DC2, DC3, DC4 and the direct-voltage units PV1, PV2, BAT to be connected. The switching unit SE can be integrated into the inverter system INV—as shown in FIG. 1 as an example. Alternatively, the switching unit SE can also be configured as an independent (external) unit, which is connected upstream of the inverter system INV.

The switching unit SE has outputs for connection to the DC inputs DC1, DC2, DC3, DC4 or to the inputs of the DC-to-DC converters B1, B2, B3, B4. These outputs are connected to the DC inputs DC1, DC2, DC3, DC4. This means that the switching unit SE knows the predetermined number of DC inputs DC1, DC2, DC3, DC4 as well as their respective properties (e.g., permissible voltage range, maximum permissible current, maximum permissible power, power transmission direction or unidirectional/bidirectional). The properties of the respective DC inputs DC1, DC2, DC3, DC4 can, for example, be stored in the switching unit SE.

Furthermore, the switching unit SE comprises inputs E1,. E6, to which the direct-voltage units PV1, PV2, BAT can be connected. For this purpose, for example, during an installation phase of the PV system, it can be predetermined which direct-voltage unit PV1, PV2, BAT is connected to which input E1, . . . , E6 of the switching unit SE. However, this assignment can be made freely. Individual inputs E1, . . . , E6 can also remain unused for the time being, for example to be able to connect additional direct-voltage units GE, EC, VB at a later time. The number of inputs E1, . . . , E6 of the switching unit SE is ideally greater than or at least equal to the number of DC inputs DC1, DC2, DC3, DC4 or outputs of the switching unit SE predetermined by the DC-to-DC converters B1, B2, B3, B4. In the inverter system INV shown as an example in FIG. 1, for example, four DC-to-DC converters B1, B2, B3, B4 are provided, which form four DC inputs DC1, DC2, DC3, DC4, while the switching unit SE comprises, for example, six inputs E1, . . . , E6, of which, for example, only three are used for the time being. For example, a PV unit PV1 is connected to an input E2 of the switching unit SE, another PV unit PV2 is connected to an input E3 of the switching unit SE, and a stationary energy storage unit or battery BAT is connected to an input E5 of the switching unit SE. The other inputs E1, E4, E6 of the switching unit SE remain unused for the time being, for example, or could be connected to other direct-voltage units GE, EC, VB, wherein the respective inputs E1, . . . , E6 can be assigned to the direct-voltage units PV1, PV2, BAT, GE, EC, VB freely.

Furthermore, the switching unit SE is configured to establish a connection between the connected direct-voltage units PV1, PV2, BAT and at least one suitable DC input DC1, DC2, DC3, DC4 and/or to adapt an existing connection, wherein adapting means that, for example, a further connection is added to an existing connection or an existing connection is removed or an existing connection is replaced by a connection to another DC input DC1, DC2, DC3, DC4 which has more favorable properties for the particular connected direct-voltage unit PV1, PV2, BAT due to the current value of the at least one power variable.

For this purpose, the switching unit SE can determine a current value of at least one power variable (e.g., a current current, a current voltage and/or a current power) for each of the direct-voltage units PV1, PV2, BAT connected to the inputs E1, . . . , E6. Furthermore, the switching unit SE is configured to compare each of the determined current power variable values with at least one predetermined threshold value and, depending on the respective comparison result, to connect the respectively connected direct-voltage units PV1, PV2, BAT to at least one suitable DC input DC1, DC2, DC3, DC4 and/or to adapt an existing connection. The switching unit SE is thus configured to determine at least one DC input DC1, DC2, DC3, DC4 with, for example, a suitable maximum permissible current, a suitable permissible voltage, a suitable maximum permissible power and/or a suitable power transmission direction (e.g., unidirectionally as a DC load, unidirectionally as a DC source, or bidirectionally) depending on the respective comparison result, and to establish the connection to the particular direct-voltage unit PV1, PV2, BAT and/or to adapt it accordingly.

If, for example, there is no connection yet between a direct-voltage unit PV1, PV2, BAT connected to the switching unit SE, the switching unit SE determines a suitable DC input DC1, DC2, DC3, DC4 based on the comparison result and establishes a connection between the direct-voltage unit PV1, PV2, BAT and the suitable DC input DC1, DC2, DC3, DC4, provided that this is not yet being used for another connected direct-voltage unit PV1, PV2, BAT.

If there are existing connections between the connected direct-voltage units PV1, PV2, BAT and the DC inputs DC1, DC2, DC3, DC4, the switching unit SE can adjust these depending on the comparison result. This means that the switching unit SE checks, based on the comparison result, whether at least one existing connection of the particular direct-voltage unit PV1, PV2, BAT to the particular DC input DC1, DC2, DC3, DC4 is still suitable—i.e., whether it provides the specific properties (e.g., permissible voltage range, maximum permissible current, maximum permissible power, power transmission direction or unidirectional/bidirectional) currently required by the direct-voltage unit PV1, PV2, BAT. Based on the comparison result, the switching unit SE can then leave the existing connection unchanged or adapt it. Adapting the existing connection means that the switching unit SE, for example, adds a further connection to a further DC input DC1, DC2, DC3, DC4 to an existing connection between a direct-voltage unit PV1, PV2, BAT and a DC input DC1, DC2, DC3, DC4 if, for example, a higher permissible current, a higher permissible voltage, etc. is required by the direct-voltage unit PV1, PV2, BAT. However, adaptation also means that the switching unit SE can also disconnect an existing connection between a direct-voltage unit PV1, PV2, BAT and a DC input DC1, DC2, DC3, DC4 if, for example, the connection is no longer required (e.g., battery BAT is charged, PV unit is in the shade or it is night, etc.) or that the switching unit SE replaces an existing connection between a direct-voltage unit PV1, PV2, BAT and a DC input DC1, DC2, DC3, DC4 of the switching unit SE with a connection to another DC input DC1, DC2, DC3, DC4 if, for example, this DC input DC1, DC2, DC3, DC4 has more favorable properties for the particular connected direct-voltage unit PV1, PV2, BAT due to the current value of the at least one power variable—e.g., if a PV unit PV1, PV2 produces more energy due to sunlight or less energy due to shading.

The switching unit SE can be used to establish connections, add connections, break connections and replace connections. In summary, the switching unit SE can flexibly assign connections—in other words, it allows a flexible and demand-oriented connection between a DC input DC1, DC2, DC3, DC4 and a direct-voltage unit PV1, PV2, BAT.

For this purpose, the switching unit SE can comprise at least one control component and a switching network, which are not shown in FIG. 1 for the sake of simplicity. The control component of the switching unit SE can, for example, be integrated into the control unit of the inverter unit INV, which controls, for example, the DC-to-DC converters B1, B2, B3, B4 and the inverter unit WE, or it can be implemented by a microcontroller in the switching unit SE. The control component of the switching unit SE is, for example, configured in such a way that, in addition to determining the current value of the at least one power variable of each of the direct-voltage units PV1, PV2, BAT connected to the inputs E1, . . . , E6 and comparing the determined current value of the at least one power variable of the connected direct-voltage unit PV1, PV2, BAT with at least one predetermined threshold value, it evaluates the respective comparison result and controls the switching network accordingly to establish and/or adapt the connection of the respectively connected direct-voltage unit PV1, PV2, BAT to the at least one suitable DC input DC1, DC2, DC3, DC4.

The respective connections between the connected direct-voltage units PV1, PV2, BAT and the DC inputs DC1, DC2, DC3, DC4 are then established or adapted accordingly by the switching network depending on the respective comparison result and controlled by the control component. The switching network can be implemented for example using transistors, relays or, in the simplest embodiment, by using manual plug connectors.

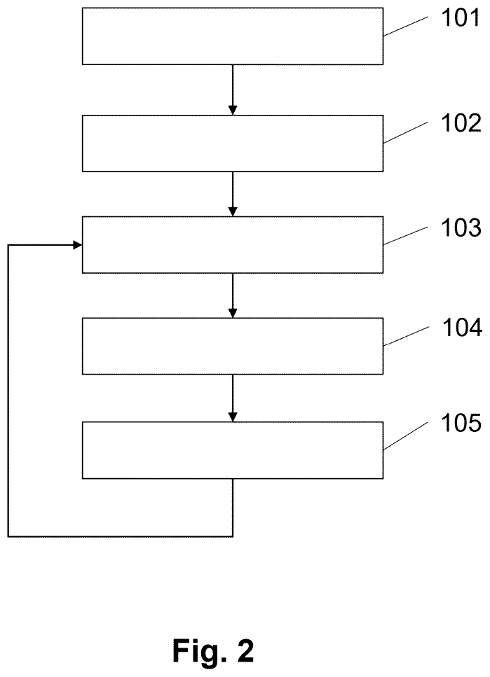

FIG. 2 shows an exemplary sequence of a method for operating the inverter system INV according to the invention for a PV system. In a start step 101, the switching unit SE or the outputs of the switching unit SE are connected to the DC inputs DC1, DC2, DC3, DC4. The start step 101 can, for example, be carried out before the installation of the PV system if the switching unit SE is configured as a stand-alone (external) unit and therefore has to be connected to the inverter system INV. If the switching unit SE is integrated into the inverter system INV, the start step 101 is already carried out during the production of the inverter unit INV. By connecting the outputs of the switching unit SE to the DC inputs DC1, DC2, DC3, DC4, for example, the number of DC inputs DC1, DC2, DC3, DC4 as well as the properties of the DC inputs DC1, DC2, DC3, DC4—such as voltage range, maximum permissible current, maximum permissible power, power transmission direction—are known and available in the switching unit SE.

In an installation step 102, the respective direct-voltage units PV1, PV2, BAT, EC, GE, VB are connected to the inputs E1, . . . , E6 of the switching unit SE. The switching unit SE is thus arranged between the DC-to-DC converters B1, B2, B3, B4 forming the DC inputs DC1, DC2, DC3, DC4 and the connected direct-voltage units PV1, PV2, BAT, EC, GE, VB. The inputs E1, . . . , E6 of the switching unit SE can be freely assigned to the respective direct-voltage units PV1, PV2, BAT, EC, GE, VB to which they are connected. For example, as shown in FIG. 1, a PV unit PV1 can be connected to an input E2 of the switching unit SE, another PV unit PV2 can be connected to an input E3 of the switching unit SE, and a stationary battery BAT can be connected to an input E5 for storing excess energy generated by the PV units PV1, PV2. The other inputs E1, E4, E6 can, for example, remain unused for the time being to connect additional direct-voltage units EC, GE, VB in a later repetition of installation step 102. Alternatively, during an initial installation step 102, direct-voltage units PV1, PV2, BAT, EC, GE, VB can be connected to all inputs E1, . . . , E6 with any assignment to the inputs E1, . . . , E6. This means that the installation step 102 can, for example, be carried out once or repeated whenever, for example, further direct-voltage units PV1, PV2, BAT, EC, GE, VB are connected to unused inputs E1, . . . , E6 or when at least one direct-voltage unit PV1, PV2, BAT, EC, GE, VB connected to an input E1, . . . , E6 is replaced by another direct-voltage unit PV1, PV2, BAT, EC, GE, VB.

Furthermore, in installation step 102, the connected direct-voltage units PV1, PV2, BAT, EC, GE, VB are identified. This means that it is at least determined which types of direct-voltage units PV1, PV2, BAT, EC, GE, VB are connected to the respective inputs E1, . . . , E6 or whether the respectively connected direct-voltage unit PV1, PV2, BAT, EC, GE, VB is a direct voltage source or load or an energy storage unit BAT, which can be both. For this purpose, for example, after the particular direct-voltage unit PV1, PV2, BAT, EC, GE, VB has been connected, the installer can enter at least one characteristic value for the particular direct-voltage unit PV1, PV2, BAT, EC, GE, VB. For example, for PV units PV1, PV2 or other direct voltage sources GE, characteristic values which could be considered would be an output voltage, a maximum output current and/or a maximum output power; for batteries BAT, for example, a charge/discharge voltage, a maximum charge/discharge current, a state of charge (SoC for short), etc.; or for direct voltage loads EC, VB, an input voltage, a maximum input current and/or a maximum power, etc.

Alternatively, the identification of the direct-voltage units PV1, PV2, BAT, EC, GE, VB connected to the switching unit SE can also be carried out automatically. For this purpose, for example, after the direct-voltage units PV1, PV2, BAT, EC, GE, VB have been connected, a measurement of characteristic values of the connected direct-voltage units PV1, PV2, BAT, EC, GE, VB or a current-voltage curve scan or I-U scan is carried out. On the basis of the measurement or the scan, it is possible to determine, for example, at least the type of the respectively connected direct-voltage unit PV1, PV2, BAT, EC, GE, VB—i.e., direct voltage source or load—and, if applicable, at least one characteristic value of the connected direct-voltage unit PV1, PV2, BAT, EC, GE, VB. The installer can then be shown a suggestion, for example, which indicates which direct-voltage unit PV1, PV2, BAT, EC, GE, VB is connected to which input E1, . . . , E6 of the switching unit SE. This suggestion can then be corrected, adjusted or simply confirmed by the installer.

Furthermore, characteristic data of the direct-voltage units PV1, PV2, BAT, EC, GE, VB connected to the switching unit SE could be read out via a data connection (e.g., PLC, Modbus) and evaluated by the switching unit SE to identify the direct-voltage units PV1, PV2, BAT, EC, GE, VB connected.

Furthermore, in installation step 102, the connected direct-voltage units PV1, PV2, BAT, EC, GE, VB can be assigned priorities, for example. These priorities can be evaluated, for example, by the switching unit SE when a connection is established between the connected direct-voltage units PV1, PV2, BAT, EC, GE, VB and the DC inputs DC1, DC2, DC3, DC4. It can be determined that, for example, a stationary battery BAT for storing excess generated energy is preferably connected to other energy storage units or charging devices EC as long as it is not yet fully charged.

After the direct-voltage units PV1, PV2, BAT, EC, GE, VB have been connected to the inputs E1, . . . , E6 of the switching unit SE and identified, a current value of at least one power variable of the respective connected direct-voltage unit PV1, PV2, BAT, EC, GE, VB is determined for each direct-voltage unit PV1, PV2, BAT, EC, GE, VB connected to an input E1, . . . , E6 of the switching unit SE in a determination step 103. Depending on the type of direct-voltage unit PV1, PV2, BAT, EC, GE, VB connected, a current input/output voltage, a current input/output current and/or a current input/output power can be used as the power variable, for example. In the inverter system INV shown in FIG. 1, for example, a current value of the output voltage, the output current and/or the output power may be determined as a power variable for the PV unit PV1 connected to the input E2 of the switching unit SE—as well as for the additional PV unit PV2 connected to the input E3. For the stationary battery BAT connected to input E5, for example, a current value of the charging current and/or the state of charge (SoC) may be determined when it is being charged, or a current value of the discharging current and/or the depth of discharge (DoD) when it is being discharged. An input voltage and/or an input power may be determined by the switching unit SE, for example, with a DC voltage sink VB, EC connected to an input E1, . . . , E6.

In a subsequent comparison step 104, the current value of the at least one power variable determined for each direct-voltage unit PV1, PV2, BAT, EC, GE, VB is compared with at least one predetermined threshold value. Depending on the power variable used, for example current limits, voltage limits and/or power limits can be used as predetermined threshold values. For connected energy storage units BAT, threshold values based on a charge and/or discharge state would also be possible. Several threshold values may be predetermined for direct-voltage units PV1, PV2, BAT, EC, GE, VB, for which, for example, the current values of the at one power variable can fluctuate or change significantly, such as PV units PV1, PV2. The respective predetermined threshold values can be defined based on the properties of the DC inputs (e.g., voltage range, maximum permissible current and/or maximum permissible power), for example.

In a connection step 105, the comparison result for each connected direct-voltage unit PV1, PV2, BAT, EC, GE, VB is evaluated by the switching unit SE, in particular by the control component of the switching unit SE. Depending on the respective comparison result, the input E1, . . . , E6 of the switching unit SE, to which the respective direct-voltage unit PV1, PV2, BAT, EC, GE, VB is connected, is connected to at least one of the DC inputs DC1, . . . , DC4, which provides the suitable properties for the particular connected direct-voltage unit PV1, PV2, BAT, EC, GE, VB. This means, for example, if there is no connection yet between a direct-voltage unit PV1, PV2, BAT, EC, GE, VB connected to the switching unit SE and a DC input DC1, DC2, DC3, DC4, the switching unit SE determines a suitable DC input DC1, DC2, DC3, DC4 based on the comparison result and establishes a connection between the direct-voltage unit PV1, PV2, BAT, EC, GE, VB and the suitable DC input DC1, DC2, DC3, DC4, provided that the suitable DC input DC1, DC2, DC3, DC4 is not yet being used by any other direct-voltage unit PV1, PV2, BAT, EC, GE, VB

If there is already at least one connection between the input E1, . . . , E6 of the switching unit SE, to which the particular direct-voltage unit PV1, PV2, BAT, EC, GE, VB is connected, and at least one of the DC inputs DC1, DC2, DC3, DC4, the connection can be adapted based on the comparison result. The switching unit SE may check whether a DC input DC1, DC2, DC3, DC4 connected to the particular direct-voltage unit PV1, PV2, BAT, EC, GE, VB is still appropriate based on the comparison result, for example. Accordingly, for example, a further connection to another DC input DC1, DC2, DC3, DC4 can be added to an existing connection between a direct-voltage unit PV1, PV2, BAT, EC, GE, VB and a DC input DC1, DC2, DC3, DC4. I.e., for example, the input E1, . . . , E6 of the particular direct-voltage unit PV1, PV2, BAT, EC, GE, VB is connected to another DC input DC1, DC2, DC3, DC4 if, for example, at least one threshold value is exceeded.

Alternatively, an existing connection between a direct-voltage unit PV1, PV2, BAT, EC, GE, VB and a DC input DC1, DC2, DC3, DC4 can also be disconnected by the switching unit SE when adapting the connections, e.g., because the connection is not currently needed (e.g., battery BAT is fully charged, PV unit PV1, PV2 is in the shade, etc.). For this purpose, the connection between the input E1, . . . , E6 of the particular direct-voltage unit PV1, PV2, BAT, EC, GE, VB and at least one DC input DC1, DC2, DC3, DC4 is disconnected, for example. Furthermore, it is also possible that an existing connection between a direct-voltage unit PV1, PV2, BAT, EC, GE, VB and a DC input DC1, DC2, DC3, DC4 is replaced by the switching unit SE with a connection to another DC input DC1, DC2, DC3, DC4 when adapting the connections, if this DC input DC1, DC2, DC3, DC4 provides more favorable properties for the particular connected direct-voltage unit PV1, PV2, BAT, EC, GE, VB due to the present value of at least one power variable, for example—e.g., if a PV unit PV1, PV2 produces more energy due to solar radiation or less energy due to shading.

Furthermore, the inverter system INV offers the option of connecting DC inputs DC1, DC2, DC3, DC4 or the associated DC-to-DC converters B1, B2, B3, B4 in series in the connection step 105, for example to extend the voltage range. This means that two or more DC inputs DC1, DC2, DC3, DC4 can be connected in series, if the voltage range of a DC-to-DC converter B1, B2, B3, B4 is no longer sufficient to increase or decrease the input voltage to a suitable output voltage, for example. This option is used, for example, to connect BAT batteries with a low voltage range—for example in the range of 50 volts—to the inverter system INV.

Furthermore, the determination step 103, the comparison step 104 and the connection step 105 can be repeated at predetermined time intervals. The steps 103, 104 and 105 can be repeated periodically (e.g., hourly, etc.) or at predetermined times (e.g., morning, noon, evening, etc.). For this purpose, the determination step 103 is carried out again after a predetermined time interval has elapsed (e.g., after one hour, etc.) or when a predetermined time is reached (e.g., 7:00 in the morning, 12:00 noon, 7:00 in the evening, etc.), to be able to determine changes in the power variables of the connected direct-voltage units PV1, PV2, BAT, EC, GE, VB, for example.

In the determination step 103, a new current value of at least one power variable of the connected direct-voltage unit PV1, PV2, BAT, EC, GE, VB is again determined for each direct-voltage unit PV1, PV2, BAT, EC, GE, VB connected to an input E1, . . . , E6 of the switching unit SE. Subsequently, when the comparison step 104 is repeated, the current value of the at least one power variable newly determined for the connected direct-voltage units PV1, PV2, BAT, EC, GE, VB is compared with the at least one threshold value. When the connection step 105 is repeated, the switching unit SE evaluates the new comparison result for each connected direct-voltage unit PV1, PV2, BAT, EC, GE, VB. The existing connections between the inputs E1, . . . , E6 of the switching unit SE, to which the respective direct-voltage units PV1, PV2, BAT, EC, GE, VB are connected, and the DC inputs DC1, DC2, DC3, DC4 are adapted depending on the comparison result from the comparison step 104. In this way, changes in the energy generation of PV units PV1, PV2 due to changes in solar radiation, shading, changes in weather conditions, etc., and/or changes in the charge/discharge status of energy storage units BAT, EC, etc. can be detected and considered, for example.

Alternatively, the determination step 103 or the comparison step 104 can also be carried out with significantly shorter period times (e.g., every second). However, to keep the switching cycles low, the frequency of the connection step 105 can be limited by hysteresis and, for example, minimum running times.

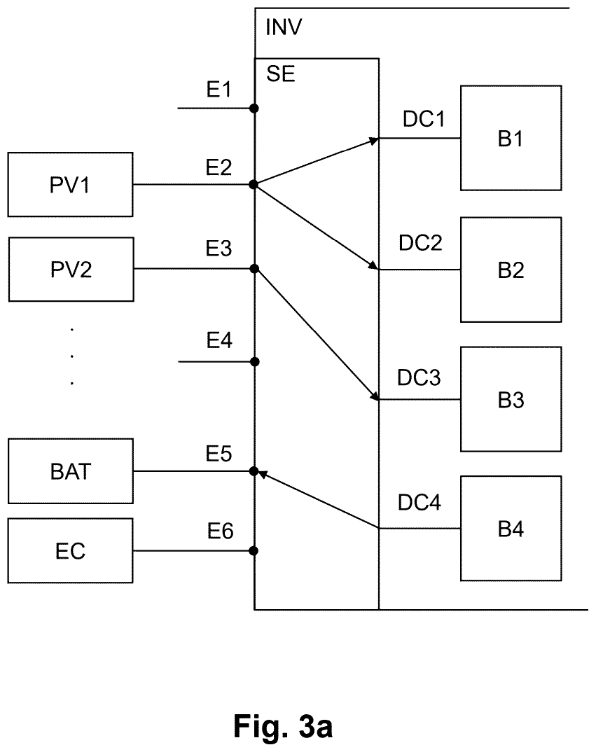

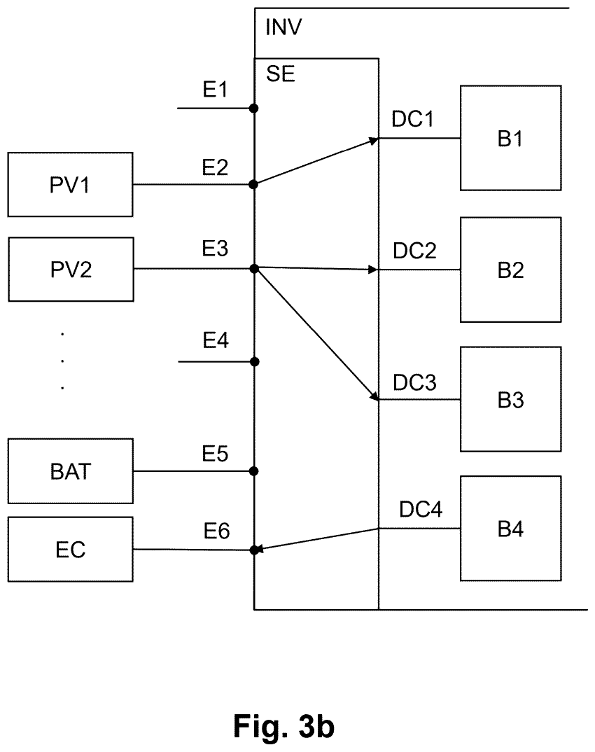

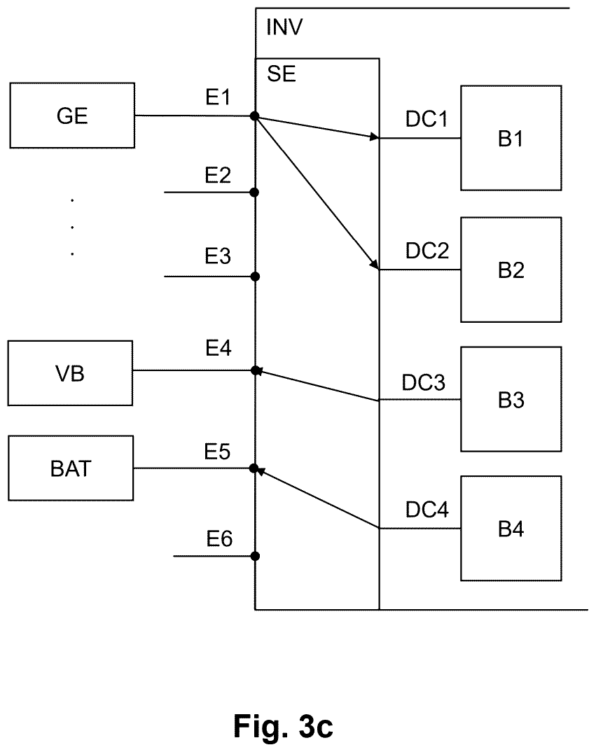

In the following, possible applications of the inverter system INV according to the invention and the associated method for operating the inverter system INV are described in more detail using examples in FIGS. 3a, 3b and 3c.

For the sake of simplicity, FIG. 3a only shows the units of the inverter system INV according to the invention that are relevant for the method. The DC inputs DC1, DC2, DC3, DC4 with the associated DC-to-DC converters B1, B2, B3, B4, which define the properties of the respective DC inputs DC1, DC2, DC3, DC4, are shown as examples. For example, a first DC-to-DC converter B1 forms a first DC input DC1, a second DC-to-DC converter B2 forms a second DC input DC2, a third DC-to-DC converter B3 forms a third DC input DC3 and a fourth DC-to-DC converter B4 forms a fourth DC input DC4. For example, the DC-to-DC converters B1, B2, B3, B4 could be dimensioned and configured differently. For example, the first and second DC-to-DC converters B1, B2 can be configured unidirectionally with a power transmission from the output of the switching unit SE to the inverter WE. The third and fourth DC-to-DC converters B3, B4 can be configured bidirectionally, for example, and thus transmit power in both directions. With regard to voltage ranges, maximum permissible current and/or maximum permissible power, for example, the DC-to-DC converters B1, B2, B3, B4 can be configured identically or differently. Furthermore, the switching unit SE is shown, which is connected on the output side to the DC inputs DC1, DC2, DC3, DC4.

The inputs E1, . . . , E6 of the switching unit SE, which also form the inputs E1, . . . , E6 of the inverter system INV, are connected to two differently oriented PV units PV1, PV2, a stationary battery BAT for storing excess energy generated and a charging device EC for an electric car with any assignment. For example, an east-facing PV unit PV1 is connected to the input E2 of the switching unit SE, another west-facing PV unit PV2 is connected to the input E3 of the switching unit SE, the stationary battery BAT is connected to the input E5 of the switching unit SE and the charging device EC is connected to the input E6 of the switching unit SE. After the installation step 102, the switching unit SE knows at least one characteristic value of the connected direct-voltage units PV1, PV2, BAT, EC. If necessary, the direct-voltage units PV1, PV2, BAT, EC are provided with priorities which can be considered by the switching unit SE when establishing the connections to the DC inputs DC1, DC2, DC3, DC4.

If the determination step 103 is now carried out by the switching unit SE at a predetermined time (e.g., at 7:00 or 8:00 in the morning) and the current value of the at least one power variable is determined for each of the connected direct-voltage units PV1, PV2, BAT, EC, the switching unit SE can determine in the comparison step 104 that the current value of an output voltage, an output current and/or an output power of the east-facing PV unit PV1, which is exposed to strong sunlight at the predetermined time or in the morning, for example, exceeds the at least one or even further predetermined threshold values, for example. In connection step 105, the switching unit SE establishes a connection between the first and second DC inputs DC1, DC2 and the input E2 of the east-facing PV unit PV1, for example, to be able to optimally use the power from the east-facing PV unit PV1. Furthermore, it is determined in comparison step 104, for example, that the west-facing PV unit PV2, which is rather shaded at the predetermined time or in the morning, for example, delivers a current output voltage, output current and/or output power value which just exceeds the at least one predetermined threshold value, for example. Therefore, the input E3 of the west-facing PV unit PV2 is only connected to the third DC input DC3 in connection step 105, to also utilize the power of the west-facing PV unit PV2.

Furthermore, the current values of the repsective, at least one power variable (e.g., charging current, SoC) determined for the stationary battery BAT and the charging device EC are compared with corresponding predetermined threshold values in comparison step 104. It is determined that, for example, the determined current value of the power variable of the battery BAT (e.g., charging current, SoC) is above the corresponding predetermined threshold value (e.g., for the charging current) or below the corresponding predetermined threshold value (e.g., for the SoC)—i.e., the battery BAT can currently be charged or is being charged, for example. In addition, it can also be determined in comparison step 104 that the charging device EC connected to input E6, for example, has a lower priority than the stationary battery BAT connected to input E5. Therefore, the input E5 of the switching unit SE, to which the battery BAT is connected, and not the input E6 of the switching unit SE, is connected to the charging device EC, e.g., to the remaining fourth DC input DC4, which is bidirectional and also allows the battery BAT to be discharged, in connection step 105, for example. Alternatively, however, it can also be determined in comparison step 105 that, for example, the charging device EC connected to input E6 is not in use or that the electric car battery is fully charged because the current value of the particular power variable (e.g., charging current, etc.) is below the predetermined threshold value, for example, and therefore no connection to a DC input DC1, DC2, DC3, DC4 is necessary.

In FIG. 3b, as in FIG. 3a, the inverter system INV comprising the four DC-to-DC converters B1, B2, B3, B4, which form the four DC inputs DC1, DC2, DC3, DC4, and the switching unit SE are shown as an example, to which the east-facing PV unit PV1 is connected at the input E2, the west-facing PV unit PV2 at the input E3, the stationary battery BAT at the input E5 and the charging device EC at the input E6.

The determination step 103 is now carried out again, for example, after a predetermined time interval—e.g., after 8 hours—or at a predetermined time, e.g., at noon (e.g., 12:00) or early afternoon (e.g., 13:00)—to determine current values of the particular at least one power variable for each connected direct-voltage unit PV1, PV2, BAT, EC again. Since the solar radiation or shading at the PV units PV1, PV2 has changed in the meantime, changed current values are now determined for the PV units PV1, PV2 connected to the respective inputs E2, E3 of the switching unit SE. In comparison step 104, it is now determined, for example, that the current power variable value (e.g., output voltage, output current and/or output power) of the east-facing PV unit PV1 has fallen below a predetermined threshold value. The connection of the input E2 of the east-facing PV unit PV1 is therefore adapted accordingly in connection step 105, for example by breaking the connection between the input E2 of the switching unit E2 and the second DC input DC2. For example, the east-facing PV unit PV1 is then connected to the first DC input DC1 only to use the remaining generated energy. If the determined current value of the at least one power variable had dropped even further, e.g., due to changes in shading, weather, etc., the connection to the first DC input DC1 could also be disconnected.

Furthermore, it is determined in comparison step 104 that the determined current value of the at least one power variable of the west-facing PV unit PV2 has increased. For example, another predetermined threshold is exceeded. Therefore, in connection step 105, the connection of the input E3, to which the west-facing PV unit PV2 is connected, is now adapted such that the input E3 of the switching unit SE is now connected to the freed-up second DC input DC2 in addition to the third DC input DC3 to make optimal use of the energy generated. With the inverter system INV and the associated method it is thus possible to make optimum use of PV systems having, for example, east-west oriented PV units PV1, PV2, and to connect the respective PV units PV1, PV2 which generate more energy due to solar radiation to a corresponding number of DC inputs DC1, DC2, DC3 and/or correspondingly dimensioned DC inputs DC1, DC2, DC3, DC4.

Furthermore, in the case of differently dimensioned DC-to-DC converters or DC inputs DC1, DC2, DC3, DC4 of the inverter system INV, a PV unit PV1, PV2 could be switched by the switching unit SE from a connection with, for example, two smaller dimensioned DC inputs DC1, DC2, DC3, DC4 to, for example, one larger dimensioned DC input DC1, DC2, DC3, DC4 or from one larger dimensioned DC input DC1, DC2, DC3, DC4 to, for example, smaller dimensioned DC inputs DC1, DC2, DC3, DC4, depending on the energy generated, by executing the determination step 103, the comparison step 104 and the connection step 105. It is also possible, for example, to switch the inputs E1, . . . , E6 of two PV units PV1, PV2 to the same DC input DC1, DC2, DC3, DC4, provided that the voltage level of the PV units PV1, PV2 matches. This allows the number of DC inputs DC1, DC2, DC3, DC4 as well as the DC inputs DC1, DC2, DC3, DC4 themselves to be used optimally.

Furthermore, it can be determined the stationary battery BAT has been charged in the meantime, for example, when the determination step 103 and the comparison step 104 shown in FIG. 3b are repeated after a time interval of, for example, 8 hours or at a predetermined time (for example, noon or early afternoon), since the determined current value of at least one power variable (for example, charging current, SoC) is below the predetermined threshold value (e.g., for the charging current), for example, or above the predetermined threshold value (e.g., for the SoC) for example. In connection step 105, the connection between the input E5 of the switching unit SE, to which the battery BAT is connected, is therefore adapted such that the connection to the fourth DC input DC4 is disconnected, for example. Since the fourth DC input DC4—e.g., bidirectional—is now free, the fourth DC input DC4 can now be connected to the input E6 of the switching unit SE, to which the charging device EC, having a lower priority, is connected, provided that it is in use, to charge an electric car battery, for example.

FIG. 3c shows another exemplary application of the inverter system INV and the associated operation method. For example, a DC generator GE is connected to the input E1 of the inverter system INV or the switching unit SE due to the season, weather, etc., in a repetition of installation step 102, to be used as a back-up for the PV units PV1, PV2 or for the supply network EV, both not shown in FIG. 3c. Furthermore, a DC voltage sink VB or a DC consumer VB (e.g., DC heating unit) is connected to input E4 of the switching unit SE, and the stationary battery BAT, which is, for example, quite discharged, is connected to input E5. The switching unit SE or the inverter system INV knows the respectively connected direct-voltage units GE, VB, BAT due to the identification in installation step 102. In the determination step 103, current values of the respective at least one power variable, which is, for example, specific to the respective direct-voltage unit GE, VB, BAT, are again determined for each of the connected direct-voltage units GE, VB, BAT. The determined current values are compared with corresponding predetermined threshold values in the comparison step 104, and in the connection step 105, the inputs E1, E4, E5 are connected to the suitable DC inputs DC1, DC2, DC3, DC4 depending on the respective comparison result. For example, the input E1 of the DC generator GE can be connected to one or both of the unidirectional DC inputs DC1, DC2. The input E4 of the DC consumer VB is connected, for example, to the bidirectional third DC input DC3 to be supplied with energy, and the input E5 of the battery BAT is connected, for example, to the bidirectional fourth DC input DC4 to be charged, for example, with excess energy from the DC generator.

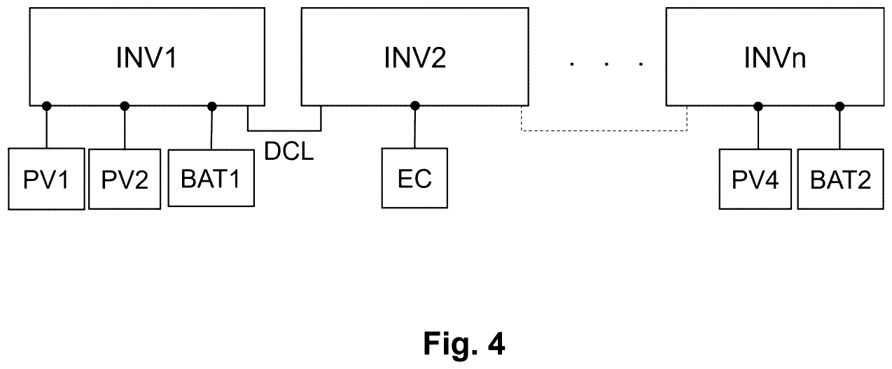

Furthermore, as shown by way of example in FIG. 4, it is possible to connect two or more inverter systems INV1, INV2, . . . , INVn together, for example by connecting an input E1, . . . , E6 of the switching unit SE of a first inverter system INV1 to an input E1, . . . , E6 of the switching unit SE of a second inverter system INV2 via a connection DCL. In this way, for example, energy can be transferred directly from the first inverter system INV1 to the second inverter system INV2. This means that energy generated, for example, by a PV unit PV1, PV2 connected to the first inverter system INV1 is transferred via the connection DCL to the charging device EC connected to the second inverter system INV2 for an electric car or to a stationary battery BAT2 connected to another inverter system INVn, for example.

For this purpose, the intermediate circuits ZK located in each of the inverter systems INV1, INV2, . . . , INVn are connected by one of the DC inputs DC1, DC2, DC3, DC4 of the inverter systems INV1, INV2, . . . , INVn, which are to be connected together, for example. For example, a positive and a negative side of an intermediate circuit ZK of the first inverter system INV1 are connected to a positive and a negative side of an intermediate circuit ZK of the second inverter system INV2, wherein the voltages of the respective intermediate circuits ZK must first be adapted and aligned before they can be connected together. Once the voltages of the intermediate circuits ZK have been adapted, the connection DCL between the inverter systems INV1, INV2 can be closed via the switching unit SE. By setting up such an electrical connection DCL between two or more inverter systems INV1, INV2, . . . , INVn, the individual intermediate circuits ZK of the individual inverter systems INV1, INV2, . . . , INVn can be regarded as one large intermediate circuit ZK. An appropriate energy management or control system ensures that the DC link voltage remains constant and energy flows are regulated in a controlled manner.

The total capacity (or stored energy) is increased and can be used, for example, to cover current peaks when setting up an emergency power system or to better cushion current peaks during emergency power operation, by interconnecting two or more inverter systems INV1, INV2, . . . , INVn or their intermediate circuits ZK. This increases the stability and resilience of an emergency power system.

Furthermore, the combination of two or more inverter systems INV1, INV2, . . . , INVn or their intermediate circuits ZK allows direct DC energy transfer between the inverter systems INV1, INV2, . . . , INVn. This means that, for example, the charging device EC for the battery of an electric car which is connected, for example, to the second inverter system INV2 can be charged from a stationary battery BAT1 which is connected to the first inverter system INV1. Ideally, the energy transfer does not first have to be converted to an alternating voltage by the first inverter system INV1, transferred to the second inverter system INV2 and then converted back to a direct voltage by the latter.

Furthermore, the combination of two or more inverter systems INV1, INV2, . . . , INVn or their intermediate circuits ZK represents an extension of the number of DC inputs DC1, DC2, DC3, DC4 of a single inverter system INV1, INV2, . . . , INVn, thereby increasing local flexibility. For example, the first inverter system INV1, to which one or more PV units PV1, PV2 and/or a stationary battery BAT1 are connected, can be installed, for example, in the attic of a building or in the vicinity of the PV units PV1, PV2. The second inverter system INV2, to which, for example, a charging device EC for charging a battery of an electric car is connected, can be installed, for example, in a garage or near the charging device EC. By combining the two inverter systems INV1, INV2 or their intermediate circuits ZK, energy from the PV units PV1, PV2 and/or the stationary battery BAT1 can be used directly by using the first and second inverter system INV1, INV2 to charge the battery of the electric car in the garage.

1. A method for operating an inverter system for a photovoltaic system, the inverter system comprising an inverter unit, to which a predetermined number of DC-to-DC converters is connected upstream via an intermediate circuit, the DC-to-DC converters forming DC inputs of the inverter system and predetermining the number and properties of the DC inputs, wherein the DC inputs are connected to different direct-voltage units, wherein a switching unit comprising inputs for connecting the direct-voltage units is connected to the DC inputs, wherein the direct-voltage units are connected to the inputs of the switching unit, the switching unit being arranged between the DC-to-DC converters forming the DC inputs and the direct-voltage units connected to the switching unit, wherein the different direct-voltage units are identified, wherein a current value of at least one power variable is determined for each direct-voltage unit connected to an input of the switching unit, wherein the determined current value of the at least one power variable is compared with at least one predetermined threshold value, and wherein depending on the respective comparison result, the switching unit determines at least one suitable DC input for the respectively connected direct-voltage unit, the at least one suitable DC input having suitable properties for the respectively connected direct-voltage unit, and then establishes a connection between the respectively connected direct-voltage unit and the at least one determined suitable DC input and/or adapts an existing connection with a suitable DC input.

2. The method according to claim 1, wherein the current value of at least one power variable for each of the direct-voltage units connected to the inputs of the switching unit is determined again at predetermined time intervals

3. The method according to claim 1, wherein an input or output voltage, an input or output current and/or a power of the respectively connected direct-voltage unit is used as the power variable.

4. The method according to claim 1, wherein, after connecting the direct-voltage units to the inputs of the switching unit, at least one characteristic value for each of the connected direct-voltage units is entered for identification of the respectively connected direct-voltage units.

5. The method according to claim 1, wherein, after connecting the direct-voltage units to the inputs of the switching unit, at least one characteristic value for each of the connected direct-voltage units is automatically determined for identification of the respectively connected direct-voltage units.

6. The method according to claim 1, wherein the inputs of the switching unit, to which the direct-voltage units are connected, are freely assigned to the different direct-voltage units.

7. The method according to claim 1, wherein each connected direct-voltage unit is assigned a priority, being taking into account when establishing the connection to at least one DC input.

8. An inverter system for a photovoltaic system, comprising an inverter unit, to which a predetermined number of DC-to-DC converters is connected upstream via an intermediate circuit, the DC-to-DC converters forming the DC inputs of the inverter system and predetermining the number and properties of the DC inputs, wherein the DC inputs are connectable to different direct-voltage units, wherein the inverter system comprises a switching unit comprising inputs for connecting the different direct-voltage units and outputs for connecting to the DC inputs, wherein the switching unit is arranged between the DC-to-DC converters forming the DC inputs and the direct-voltage units connected to the switching unit, and wherein the switching unit is configured to determine a current value of at least one power variable for each of the direct-voltage units connected to the inputs to compare the determined current value of the at least one power variable of the direct-voltage units connected to the inputs with at least one predetermined threshold value, to determine, depending on a respective comparison result, at least one suitable DC input for the direct-voltage units connected to the inputs, the at least one suitable DC input having suitable properties for a respectively connected direct-voltage unit, and to establish a connection between the respectively connected direct-voltage units and the at least one determined suitable DC input and/or adapt an existing connection to a suitable DC input.

9. The inverter system according to claim 8, wherein a number of inputs of the switching unit is greater than or at least equal to the predetermined number of DC-to-DC converters and DC inputs.

10. The inverter system according to claim 8, wherein at least one DC-to-DC converter are configured as a bidirectional DC-to-DC converter.

11. The inverter system according to claim 8, wherein the DC-to-DC converters have the same dimensioning and the same design in terms of voltage range, maximum permissible current and/or maximum permissible power.

12. The inverter system according to claim 8, wherein the DC-to-DC converters are dimensioned and configured for different voltage ranges, different maximum permissible currents and/or different maximum permissible power.

13. The inverter system according to claim 8, wherein the switching unit comprises at least one switching network for connecting the connected direct-voltage units to the DC inputs and a control component, which, in addition to determining the current value of the at least one power variable of the direct-voltage units connected to the inputs and comparing the determined current value of the at least one power variable with at least one threshold value, is configured to evaluate the relevant comparison result and control the switching network accordingly.

14. The inverter system according to claim 13, wherein the control component is integrated into a control unit of the inverter system.
